(19) United States
(12) Patent Application Publication
(10) Pub. No.: US 2026/0072285 A1
(43) Pub. Date: Mar. 12, 2026

(54) AUTOMATED INTERPUPILLARY DISTANCE ESTIMATION AND DEVICE ADJUSTMENT FOR EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/063,046

(22) Filed: Feb. 25, 2025

Related U.S. Application Data
(60) Provisional application No. 63/691,844, filed on Sep. 6, 2024.

(51) Int. Cl. G02B 27/01; G02B 27/00; H04N 13/117; H04N 13/128

(52) U.S. Cl. CPC G02B 27/0179; G02B 27/0093; G02B 27/0172; H04N 13/117; H04N 13/128; G02B 2027/0138; G02B 2027/014; G02B 2027/0187

(57) ABSTRACT

An apparatus configured to be worn on a head of a user includes at least one display configured to present one or more rendered images or videos to the user and at least one eye-tracking sensor configured to track eyes of the user. The apparatus also includes at least one processing device configured to (i) obtain eye-tracking data captured using the at least one eye-tracking sensor while the user is focusing on a point, object, or pattern within at least one rendered image or video presented on the at least one display and (ii) determine an interpupillary distance of the user based on the eye-tracking data.

### CROSS-REFERENCE TO RELATED APPLICATION AND PRIORITY CLAIM

This application claims priority under 35 U.S.C. § 119 (e) to U.S. Provisional Patent Application No. 63/691,844 filed on Sep. 6, 2024. This provisional patent application is hereby incorporated by reference in its entirety.

### TECHNICAL FIELD

This disclosure relates generally to extended reality (XR) systems and processes or other systems and processes involving users. More specifically, this disclosure relates to automated interpupillary distance estimation and device adjustment for XR or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to automated interpupillary distance estimation and device adjustment for extended reality (XR) or other applications.

In a first embodiment, an apparatus configured to be worn on a head of a user includes at least one display configured to present one or more rendered images or videos to the user and at least one eye-tracking sensor configured to track eyes of the user. The apparatus also includes at least one processing device configured to (i) obtain eye-tracking data captured using the at least one eye-tracking sensor while the user is focusing on a point, object, or pattern within at least one rendered image or video presented on the at least one display and (ii) determine an interpupillary distance of the user based on the eye-tracking data.

In a second embodiment, a method includes presenting one or more rendered images or videos to a user on at least one display of a device configured to be worn on a head of the user. The method also includes tracking eyes of the user using at least one eye-tracking sensor to generate eye-tracking data captured while the user is focusing on a point, object, or pattern within at least one rendered image or video presented on the at least one display. The method further includes determining an interpupillary distance of the user based on the eye-tracking data.

In a third embodiment, a non-transitory machine readable medium contains instructions that when executed cause at least one processor of an electronic device configured to be worn on a head of a user to initiate presentation of one or more rendered images or videos to the user on at least one display of the electronic device. The non-transitory machine readable medium also contains instructions that when executed cause the at least one processor to obtain eye-tracking data associated with eyes of the user from at least one eye-tracking sensor while the user is focusing on a point, object, or pattern within at least one rendered image or video presented on the at least one display. The non-transitory machine readable medium further contains instructions that when executed cause the at least one processor to determine an interpupillary distance of the user based on the eye-tracking data.

Any one or any combination of the following features may be used with the first, second, or third embodiment. Display lenses may be configured to be positioned between the at least one display and the user's eyes, and one or more actuators may be configured to adjust positions of the display lenses. The one or more actuators may be controlled to adjust the positions of the display lenses based on the determined interpupillary distance of the user. One or more mappings between one or more views of at least one imaging sensor and positions of the user's eyes may be obtained, and the one or more mappings may be based on the determined interpupillary distance of the user. One or more transformations of image frames captured by the at least one imaging sensor may be performed based on the one or more mappings after adjustment of the positions of the display lenses to generate transformed image frames. The transformed image frames may be rendered for presentation on the at least one display. A comparison of (i) the determined interpupillary distance of the user and (ii) one or more stored interpupillary distances may be made. In response to the determined interpupillary distance of the user differing from the one or more stored interpupillary distances by at least a threshold, the one or more mappings may be created, and the determined interpupillary distance and the one or more mappings may be stored in at least one memory. In response to the determined interpupillary distance of the user not differing from a specified one of the one or more stored interpupillary distances by at least the threshold, the one or more mappings associated with the specified stored interpupillary distance may be retrieved from the at least one memory. The eye-tracking data may include at least one of: a focal point for at least one of the user's eyes, a focal distance for at least one of the user's eyes, or an eye gaze direction for at least one of the user's eyes. At least one imaging sensor may be configured to capture image frames of a scene, at least one depth sensor may be configured to identify depth data associated with the scene, and the interpupillary distance of the user may be based on the depth data. Positions of pupils of the user's eyes may be identified in a global coordinate system, and the interpupillary distance of the user may be based on the identified positions of the pupils.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example technique for automated interpupillary distance estimation based on eye tracking in accordance with this disclosure;

FIG. 3 illustrates a portion of an example extended reality (XR) headset for illuminating a user's eye in accordance with this disclosure;

FIG. 4 illustrates an example process for automated interpupillary distance estimation and device adjustment for XR or other applications in accordance with this disclosure;

FIGS. 5A through 5C illustrate example functions in the process of FIG. 4 in accordance with this disclosure;

FIG. 6 illustrates an example architecture supporting automated interpupillary distance estimation and device adjustment for XR or other applications in accordance with this disclosure;

FIG. 7 illustrates an example technique for interpupillary distance estimation based on eye focal point tracking in accordance with this disclosure;

FIGS. 8 and 9 illustrate example relationships associated with interpupillary distance estimation based on eye focal point tracking in accordance with this disclosure;

FIG. 10 illustrates an example process for device adjustment based on automated interpupillary distance estimation in accordance with this disclosure;

FIG. 11 illustrates an example process for passthrough transformation mapping based on automated interpupillary distance estimation in accordance with this disclosure; and

FIG. 12 illustrates an example method for automated interpupillary distance estimation and device adjustment for XR or other applications in accordance with this disclosure.

### DETAILED DESCRIPTION

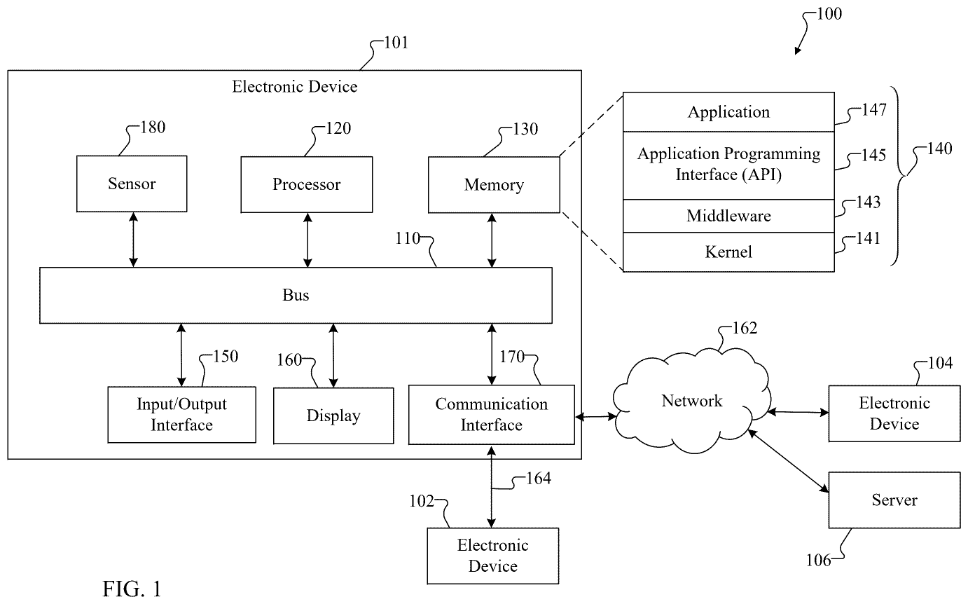

FIGS. 1 through 12, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Interpupillary distance (IPD) can be useful or important in designing and using XR devices and in a number of other applications. Interpupillary distance refers to the distance between the centers of the pupils of a person's eyes. Often times, each individual user's interpupillary distance needs to be known so that an XR device can be adjusted for use by that individual user. Among other things, this may allow each user to see correct final views generated by that user's XR device. One common way of measuring interpupillary distance is through the use of a device called an Essilor pupilometer. However, most people do not have easy access to a pupilometer, and requiring each user of an XR device to have access to a pupilometer can interfere with that user's usage of his or her XR device.

This disclosure provides various techniques supporting automated interpupillary distance estimation and device adjustment for XR or other applications. As described in more detail below, one or more rendered images or videos may be presented to a user on at least one display of a device configured to be worn on a head of the user, such as an XR headset or other electronic device. At least one eye-tracking sensor can track eyes of the user and generate eye-tracking data that is captured while the user is focusing on a point, object, or pattern within at least one rendered image or video presented on the at least one display. An interpupillary distance of the user can be determined based on the eye-tracking data. In some cases, display lenses may be configured to be positioned between the at least one display and the user's eyes, and one or more actuators may be configured to adjust positions of the display lenses. The one or more actuators can be controlled to adjust the positions of the display lenses based on the determined interpupillary distance of the user. Also, in some cases, one or more mappings used for passthrough transformation of captured image frames of a scene can be generated or retrieved based on whether the determined interpupillary distance of the user is or is not similar to a previously-determined interpupillary distance.

In this way, the disclosed techniques provide an efficient mechanism to determine the interpupillary distance of a user and optionally to make adjustments to a device worn by the user based on the determined interpupillary distance. This may allow, for example, more efficient configuration of XR headsets or other devices worn by users since their interpupillary distances can be determined and their devices can be adjusted in an automated, convenient, and accurate manner. Moreover, a pipeline used in an XR device can be designed to implement changes to rendered images based on the interpupillary distance of the user currently using the XR device, such as by creating mappings and performing transformations to generate final view images. In addition, the users are not required to have access to a pupilometer or other specialized device. Instead, the described techniques can be performed using the electronic devices worn by the users, which allows the users' interpupillary distances to be identified more easily and quickly. Overall, these techniques can significantly increase the accuracy and decrease the difficulty of generating interpupillary distance estimates and adjusting XR devices or other devices based on the interpupillary distance estimates.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to automated interpupillary distance estimation and device adjustment for XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform automated interpupillary distance estimation and device adjustment for XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to automated interpupillary distance estimation and device adjustment for XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

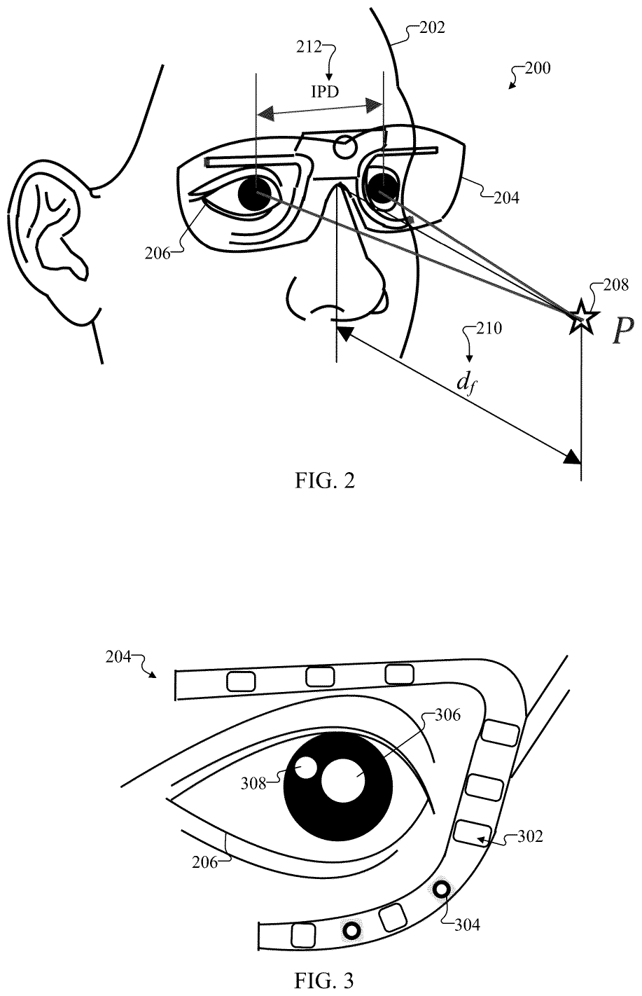

FIG. 2 illustrates an example technique 200 for automated interpupillary distance estimation based on eye tracking in accordance with this disclosure. For case of explanation, the technique 200 shown in FIG. 2 is described as being performed using or as involving the use of the electronic device 101 in the network configuration 100 shown in FIG. 1. However, the technique 200 may be performed using any other suitable device(s) and in any other suitable system(s).

As shown in FIG. 2, a user 202 is wearing a headset 204, which can represent one example implementation of the electronic device 101. In this example, the headset 204 takes the form of smart glasses. However, the headset 204 may have any other suitable form. The user 202 here is focusing his or her eyes 206 on a specified target point 208 (denoted P), which represents the focal point of the user's eyes 206. The target point 208 is located at a distance 210, which represents the focal distance (denoted d_{f}) of the user's eyes 206.

The headset 204 can include various sensors, such as eye-tracking sensors. The eye-tracking sensors can be used to estimate where the user is gazing. For example, the eye-tracking sensors may be used to identify a focal point for one or more of the user's eyes 206, a focal distance for one or more of the user's eyes 206, an eye gaze direction for one or more of the user's eyes 206, or any suitable combination thereof. As described in more detail below, information from the eye-tracking sensors can be used to estimate the focal distance 210 of the user's eyes 206.

With an adequately-accurate measure of the focal distance 210 of the user's eyes 206, it is possible to derive an estimate of the interpupillary distance 212 of the user's eyes 206. For example, the eye-tracking sensors can capture eye-tracking data (such as high-resolution or other image frames) while the user 202 is focusing his or her eyes 206 on the target point 208. The target point 208 may represent a point or object within a real-world scene or a point of a checkerboard pattern or other pattern/object/point artificially created and displayed to the user 202. The captured eye-tracking data can be used to obtain an accurate estimate of the user's focal distance 210. From this, an accurate estimate of the user's interpupillary distance 212 can be determined. Details of example approaches for estimating the user's interpupillary distance 212 are provided below.

Although FIG. 2 illustrates one example of a technique 200 for automated interpupillary distance estimation based on eye tracking, various changes may be made to FIG. 2. For example, as noted above, the headset 204 may have any other suitable form. Also, the focal point may be positioned at any suitable distance 210 from the user 202.

FIG. 3 illustrates a portion of an example XR headset 204 for illuminating a user's eye 206 in accordance with this disclosure. For ease of explanation, the headset 204 shown in FIG. 3 is described as being one example implementation of the electronic device 101 in the network configuration 100 shown in FIG. 1, where the headset 204 may be used as part of the technique 200 shown in FIG. 2. However, the headset 204 may be used in any other suitable system(s) and with any other suitable technique(s), and the electronic device 101 may be implemented in any other suitable manner.

As shown in FIG. 3, the XR headset 204 includes one or more illumination sources 302 and one or more eye-tracking imaging sensors 304. Each illumination source 302 is configured to generate illumination that can be directed at a user's eye 206. Each illumination source 302 can generate any suitable illumination, such as infrared illumination. Note that the number and positions of the illumination sources 302 shown in FIG. 3 are for illustration only. The XR headset 204 may include any suitable number of illumination sources 302, and the illumination source(s) 302 may be positioned at any suitable location(s). Each illumination source 302 represents any suitable structure configured to generate illumination for a user's eye 206, such as an infrared or other light emitting diode (LED).

Each eye-tracking imaging sensor 304 is configured to capture one or more image frames of the user's eye 206. The illumination from the illumination source(s) 302 can reflect from the user's eye 206, and these reflections can be captured in the image frames obtained using the eye-tracking imaging sensor(s) 304. In some cases, for instance, the illumination from the illumination source(s) 302 can create a reflection 306 from the pupil of the user's eye 206 and one or more reflections 308 from the cornea of the user's eye 206.

Each eye-tracking imaging sensor 304 can capture image frames of the user's eye 206 that include at least some of these reflections 306, 308. The locations of these reflections 306, 308 can be used by the XR headset 204 to identify a gaze direction or other information about where the user 202 is gazing. For instance, it is possible to analyze vectors between the pupil and corneal reflections 306, 308 to measure the gaze direction, focal point, and/or focal distance of the user's eyes 206. Each eye-tracking imaging sensor 304 includes any suitable structure configured to capture image frames of a user's eye 206, such as an infrared or other camera. In some cases, the eye-tracking imaging sensors 304 may represent imaging sensors 180 of the electronic device 101.

Although FIG. 3 illustrates one portion of an example XR headset 204 for illuminating a user's eye 206, various changes may be made to FIG. 3. For example, the XR headset 204 may have any other suitable form factor. Also, the arrangement shown in FIG. 3 can be duplicated on the opposite side of the XR headset 204, meaning each eye 206 of the user 202 may be illuminated using one or more illumination sources 302 and imaged using one or more eye-tracking imaging sensors 304.

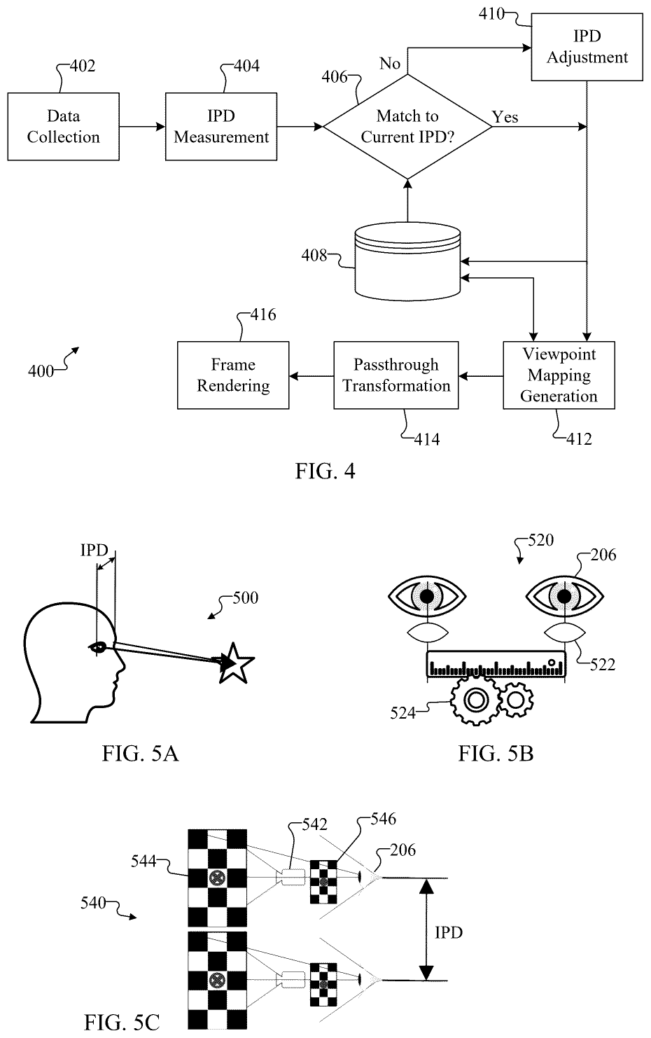

FIG. 4 illustrates an example process 400 for automated interpupillary distance estimation and device adjustment for XR or other applications in accordance with this disclosure. For case of explanation, the process 400 shown in FIG. 4 is described as being performed using or as involving the use of the electronic device 101 in the network configuration 100 shown in FIG. 1, where the electronic device 101 may have the form shown in FIGS. 2 and 3. However, the process 400 may be performed using any other suitable device(s) and in any other suitable system(s).

As shown in FIG. 4, the process 400 includes a data collection operation 402, which generally operates to obtain image frames captured by the headset 204 or other electronic device 101. The obtained image frames can include image frames of a scene captured by forward-facing or other imaging sensors 180 of the electronic device 101. In some cases, these image frames may represent high-resolution color image frames. The obtained image frames can also include image frames of the user's eyes 206 captured by the eye-tracking imaging sensors 304 of the electronic device 101. In some cases, these image frames may also represent high-resolution color image frames. The image frames of the user's eyes 206 can be captured while the user 202 is focusing on a point, object, or pattern within the scene being viewed. In some embodiments, the point or object may be associated with an actual object within a scene. In other embodiments, the point, object, or pattern may be artificially created and displayed. In addition, the data collection operation 402 may optionally obtain other information, such as depth data captured using one or more depth sensors of the electronic device 101. Any suitable pre-processing of the obtained data may be performed here.

An interpupillary distance (IPD) measurement operation 404 generally operates to process image frames and optionally other information obtained by the data collection operation 402 in order to estimate the interpupillary distance of the user 202. For example, the IPD measurement operation 404 can use eye-tracking data to compute the focal point, focal distance, and/or gaze direction of the user 202 while the user's eyes 206 are focused. As a particular example, the IPD measurement operation 404 can use the pupil and corneal reflections 306, 308 captured in the image frames of the user's eyes 206 in order to estimate the focal distance 210 of the user's eyes 206. Based on the focal distance 210 and other information, the IPD measurement operation 404 can estimate the interpupillary distance 212 of the user 202. Additional details regarding example techniques for identifying the user's interpupillary distance are provided below.

A comparison operation 406 generally operates to compare the current interpupillary distance estimate generated by the IPD measurement operation 404 with the current IPD setting of the electronic device 101. For example, the current IPD setting of the electronic device 101 may be stored in a database 408 or other suitable storage. If the current interpupillary distance estimate generated by the IPD measurement operation 404 is not the same as or similar to the current IPD setting of the electronic device 101 (such as when they differ by at least a threshold amount or percentage), an IPD adjustment operation 410 can be performed. The IPD adjustment operation 410 generally operates to adjust the current IPD setting of the electronic device 101. For instance, the electronic device 101 may include one or more digital motors or other actuators configured to adjust the positions of display lenses or other components of the electronic device 101. This allows the electronic device 101 to be automatically adjusted based on the current interpupillary distance estimate generated by the IPD measurement operation 404. The updated IPD setting of the electronic device 101 can also be stored in the database 408 or other storage for subsequent use.

A viewpoint mapping generation operation 412 generally operates to produce one or more mappings that can be used to match or substantially match the viewpoint(s) of the imaging sensor(s) 180 used to capture the image frames of the scene around the user 202 (often referred to as see-through camera(s)) and the viewpoints of the user's eyes 206. A passthrough transformation operation 414 generally operates to apply the one or more mappings to the image frames of the scene as captured by the see-through camera(s). For example, the viewpoint mapping generation operation 412 and the passthrough transformation operation 414 can be used to compensate for things like registration and parallax errors, which may be caused by factors like differences between the positions of the see-through camera(s) and the user's eyes 206. As particular examples, the viewpoint mapping generation operation 412 may identify and the passthrough transformation operation 414 may apply a rotation and/or a translation to each image frame of the scene around the user 202 captured using the see-through camera(s) in order to compensate for these or other types of issues. Ideally, the transformations give the appearance that the image frames captured at the location(s) of the see-through camera(s) were actually captured at the locations of the user's eyes 206. Often times, the rotation and/or translation can be derived mathematically based on the position and angle of each see-through camera and the expected or actual positions of the user's eyes 206. In some cases, the transformations are static (since these positions and angles will not change), allowing passthrough transformations to be applied quickly.

In some embodiments, the one or more mappings generated by the viewpoint mapping generation operation 412 may be stored in the database 408 in association with the current IPD setting of the electronic device 101. If the IPD setting of the electronic device 101 changes to an IPD setting previously seen by the electronic device 101, the one or more stored mappings may be retrieved and applied by the passthrough transformation operation 414 without recalculation by the viewpoint mapping generation operation 412. However, this is not necessarily required, and the viewpoint mapping generation operation 412 may generate one or more mappings each time the IPD setting of the electronic device 101 changes.

A frame rendering operation 416 generally operates to create final views of the scene captured in the transformed image frames generated by the passthrough transformation operation 414. The frame rendering operation 416 can also render the final views for presentation to a user of the electronic device 101. For example, the frame rendering operation 416 may process the transformed image frames and perform any additional refinements or modifications needed or desired, and the resulting images can represent the final views of the scene. For instance, a 3D-to-2D warping can be used to warp the final views of the scene into 2D images. The frame rendering operation 416 can also present the rendered images to the user. For example, the frame rendering operation 416 can render the images into a form suitable for transmission to at least one display 160 and can initiate display of the rendered images, such as by providing the rendered images to one or more displays 160. In some cases, there may be a single display 160 on which the rendered images are presented for viewing by the user 202, such as where each eye 206 of the user 202 views a different portion of the display 160. In other cases, there may be separate displays 160 on which the rendered images are presented for viewing by the user 202, such as one display 160 for each of the user's eyes 206.

Although FIG. 4 illustrates one example of a process 400 for automated interpupillary distance estimation and device adjustment for XR or other applications, various changes may be made to FIG. 4. For example, various components or functions in FIG. 4 may be combined, further subdivided, replicated, omitted, or rearranged and additional components or functions may be added according to particular needs.

FIGS. 5A through 5C illustrate example functions in the process 400 of FIG. 4 in accordance with this disclosure. As shown in FIG. 5A, one operation associated with the process 400 is an interpupillary distance estimation operation 500, which may occur as part of the IPD measurement operation 404. During the operation 500, the electronic device 101 can process image frames capturing the user's eyes 206. Using suitable image processing and other processing, the electronic device 101 can estimate the focal distance 210 or other parameters of the user's gaze while the user is focusing on a point, object, or pattern in a scene. The electronic device 101 can use the focal distance 210 or other parameters of the user's gaze to estimate the user's interpupillary distance 212.

As shown in FIG. 5B, another operation that may be associated with the process 400 is a device adjustment operation 520, which may occur as part of the IPD adjustment operation 410. During the operation 520, the electronic device 101 can adjust the positions of display lenses 522 of the electronic device 101. Each display lens 522 can be positioned between one of the user's eyes 206 and at least one display 160 of the electronic device 101. Ideally, the display lenses 522 can be centered on the user's eyes 206, meaning the optical axis of each display lens 522 is aligned with the center of the pupil of the associated eye 206. As a result, the estimated interpupillary distance of the user 202 can be used to adjust the positions of the display lenses 522, such as by increasing the spacing of the display lenses 522 when the estimated interpupillary distance of the user 202 is larger than the current IPD setting of the electronic device 101 or decreasing the spacing of the display lenses 522 when the estimated interpupillary distance of the user 202 is smaller than the current IPD setting of the electronic device 101.

The positions of the display lenses 522 may be controlled in any suitable manner. For example, the electronic device 101 may include one or more actuators 524, such as one or more digital motors. The processor 120 of the electronic device 101 may identify the interpupillary distance of the user 202 currently using the electronic device 101 and control the one or more actuators 524 to alter the positions of the display lenses 522 based on that interpupillary distance. In some cases, the processor 120 may initiate a visual, audible, or other alert or other notification informing the user 202 of the change in the positions of the display lenses 522 prior to causing the one or more actuators 524 to alter the positions of the display lenses 522.

As shown in FIG. 5C, yet another operation that may be associated with the process 400 is a transformation operation 540, which may occur as part of the viewpoint mapping generation operation 412 and the passthrough transformation operation 414. During the operation 540, the electronic device 101 can perform operations like viewpoint matching and parallax correction. These operations can be used since one or more see-through cameras 542 (which may represent one or more forward-facing or other imaging sensors 180 of the electronic device 101) can capture image frames of a scene being viewed by the user 202, but the see-through cameras 542 are positioned at locations different than the locations of the user's eyes 206. As a result, the fields of view 544 of the see-through cameras 542 differ from the fields of view 546 of the user's eyes 206. The transformation operation 540 can provide viewpoint matching, parallax correction, or other corrections so that the final rendered images presented to the user 202 by the electronic device 101 achieve the desired effects.

Although FIGS. 5A through 5C illustrate examples of functions in the process 400 shown in FIG. 4, various changes may be made to FIGS. 5A through 5C. For example, while FIG. 5C assumes that the see-through cameras 542 are pointed straight ahead and are positioned directly in front of the user's eyes 206, one or both conditions need not be true. As particular examples, the see-through cameras 542 may point outwards or inwards, and/or the see-through cameras 542 may or may not be positioned directly in front of the user's eyes 206.

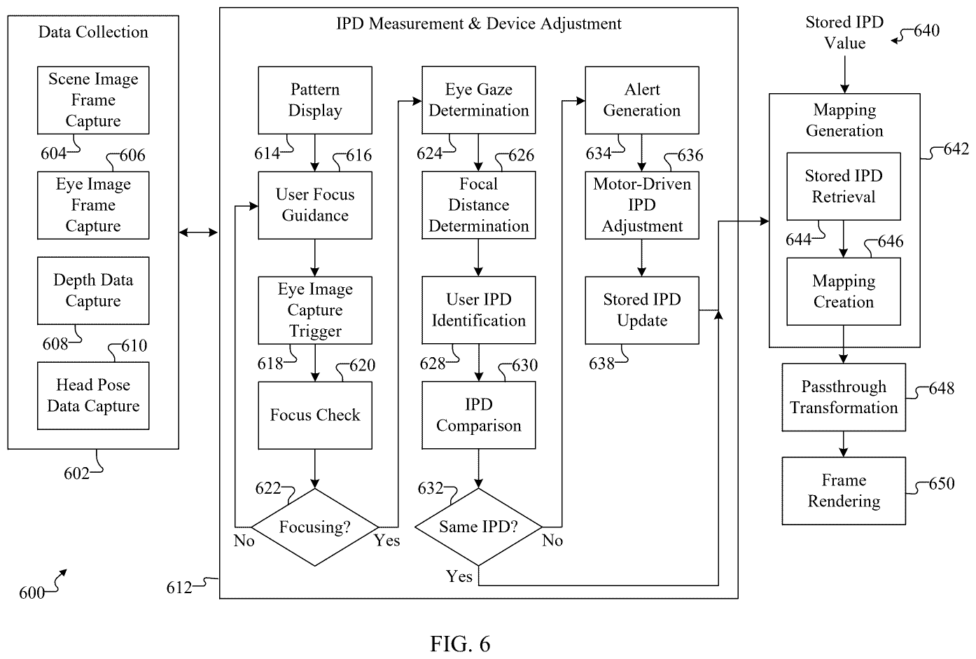

FIG. 6 illustrates an example architecture 600 supporting automated interpupillary distance estimation and device adjustment for XR or other applications in accordance with this disclosure. For case of explanation, the architecture 600 shown in FIG. 6 is described as being implemented using the electronic device 101 in the network configuration 100 shown in FIG. 1, where the electronic device 101 may have the form shown in FIGS. 2 and 3 and may implement the process 400 shown in FIG. 4. However, the architecture 600 may be implemented using any other suitable device(s) and in any other suitable system(s), and the architecture 600 may be used to implement any other suitable process(es) designed in accordance with this disclosure.

As shown in FIG. 6, a data capture operation 602 generally operates to obtain image frames and optionally other data used to perform interpupillary distance estimation and device adjustment. For example, the data capture operation 602 may include a scene image frame capture function 604 and an eye image frame capture function 606. The scene image frame capture function 604 can be used to obtain image frames of a scene to be processed using the architecture 600. These image frames may be obtained using one or more see-through cameras 542 or other imaging sensors 180 of the electronic device 101. The eye image frame capture function 606 can be used to obtain image frames of a user's eyes 206 to be processed using the architecture 600. Those image frames may be obtained using eye-tracking imaging sensors 304. Note that the number of obtained images obtained from the one or more sec-through cameras 542 and the number of obtained images obtained from the eye-tracking imaging sensors 304 can vary depending on the implementation.

The data capture operation 602 may also optionally include a depth data capture function 608 and a head pose data capture function 610. The depth data capture function 608 may be used to obtain depth maps or other depth data associated with the image frames captured using the see-through cameras 542 or other imaging sensors 180 of the electronic device 101. If the depth data capture function 608 is used, the depth data may be obtained from any suitable source(s), such as from one or more depth sensors 180 (like one or more LIDAR or time-of-flight depth sensors) of the electronic device 101. The head pose data capture function 610 may be used to obtain information identifying the pose of the user's head while the electronic device 101 is being used. If the head pose data capture function 610 is used, the head pose data may be obtained from any suitable source(s), such as from one or more positional sensors like at least one IMU.

An IPD measurement and device adjustment operation 612 generally operates to estimate the user's interpupillary distance and (if needed or desired) adjust the current IPD setting of the electronic device 101. In this example, the IPD measurement and device adjustment operation 612 includes an optional pattern display function 614. In some embodiments, the electronic device 101 may render and present a pattern or other artificial content on the display(s) 160 of the electronic device 101. The pattern can be displayed to appear at a known focal distance 210 from the perspective of the user 202. The electronic device 101 can capture image frames of the user's eyes 206 while the user focuses on the pattern and use the image frames to estimate the user's interpupillary distance 212. Any suitable pattern can be used here, such as a checkerboard pattern or a single point. Note, however, that the display of the pattern is optional since the user 202 could focus on an actual object or point within the scene.

A user focus guidance function 616 generally operates to instruct the user 202 to focus on an object, point, or pattern within the images rendered and displayed on the display(s) 160 of the electronic device 101. For example, the user focus guidance function 616 may ask the user 202 to focus his or her gaze at the center of a displayed checkerboard pattern or other pattern or to otherwise focus on an object, point, or pattern within the images rendered and displayed on the display(s) 160. If the user 202 appears to focus on the wrong location or does not focus correctly, the user focus guidance function 616 may give the user 202 guidance or ask the user 202 to focus for a longer period of time. These interactions can occur in any suitable manner, such as when the user focus guidance function 616 causes textual instructions to be displayed to the user 202 on the display(s) 160 and/or causes audible instructions to be presented to the user 202.

An eye image capture trigger function 618 can be used to trigger image capture (and optionally other data capture) by the data capture operation 602. For example, the eye image capture trigger function 618 may wait for a predetermined period of time after an instruction to focus is provided to the user 202, and the eye image capture trigger function 618 can trigger image frame capture by the eye image frame capture function 606 after the predetermined period of time elapses. A focus check function 620 can process the captured image frames and confirm whether it appears the user 202 is focusing as instructed. For instance, the focus check function 620 may use the pupil and corneal reflections 306, 308 to determine whether it appears the user 202 is focusing his or her eyes 206 inwards towards the displayed pattern or other object, point, or pattern. A focusing determination function 622 can determine whether the focus check function 620 identifies that the user 202 as focusing as instructed. If not, the user focus guidance function 616 can provide the same instructions or other/additional instructions to the user 202 so that the user 202 can change his or her focus.

Assuming the user 202 focuses as instructed, the image frames captured using the eye image frame capture function 606 can be processed by an eye gaze determination function 624 and/or a focal distance determination function 626. The eye gaze determination function 624 generally operates to estimate the gaze direction(s) of the user's eyes 206, such as based on the reflections 306, 308 of the illumination from the illumination sources 302 on the user's eyes 206. The eye gaze determination function 624 can use any suitable technique to identify the user's gaze direction(s). In some embodiments, for instance, the eye gaze determination function 624 may use a Pupil Center Corneal Reflection (PCCR) technique. Note, however, that any other suitable eye tracking technique(s) may be used here. The eye gaze determination function 624 can also confirm that the identified gaze direction or directions are suitable for further processing, such as by verifying that the user's gaze directions are aimed inward towards the center of a displayed pattern or other suitable object, point, or pattern. If not, the eye gaze determination function 624 could stop and cause control to return to the user focus guidance function 616 for additional user instruction.

The focal distance determination function 626 generally operates to estimate the focal distance 210 of the user's eyes 206. As noted above, the user's focal distance 210 represents the distance from the user's eyes 206 to the point of focus of the user's eyes 206 (the target point P). In some cases, the user's focal distance 210 can be determined by estimating where the gaze directions of the user's eyes 206 intersect. In other cases, the focal distance determination function 626 can calculate the user's focal distance 210 to a designed pattern or other object, point, or pattern based on the pupil and corneal reflections 306, 308. In general, this disclosure is not limited to any specific technique(s) for identifying the user's focal distance 210.

A user IPD identification function 628 generally operates to calculate an estimate of the user's interpupillary distance 212. For example, the user IPD identification function 628 may calculate an estimate of the user's interpupillary distance 212 based on the captured image frames of the user's eyes 206, the identified gaze direction(s) of the user's eyes 206, and the identified focal distance 210. The user IPD identification function 628 can use any suitable technique(s) to identify interpupillary distance estimates, such as the techniques described in more detail below.

A comparison function 632 determines if the calculated estimate of the user's interpupillary distance matches or is substantially similar to the current IPD setting of the electronic device 101 (at least to within a threshold amount or percentage). If the calculated estimate of the user's interpupillary distance adequately differs from the current IPD setting of the electronic device 101, an alert generation function 634 may be used to present an alert to the user 202 indicating that the current IPD setting of the electronic device 101 is about to change. This alert can be displayed to the user 202 on the display(s) 160 of the electronic device 101, played audibly to the user via one or more speakers of the electronic device 101, or presented in any other suitable manner. A motor-driven IPD adjustment function 636 can also be used to automatically adjust the current IPD setting of the electronic device 101, such as by controlling the one or more actuators 524 in order to move the display lenses 522 inward or outward depending on the estimate of the user's interpupillary distance. A stored IPD update function 638 can store the new IPD setting of the electronic device 101, such as in the database 408 or other suitable storage. If the comparison function 632 determines that the calculated estimate of the user's interpupillary distance matches or is substantially similar to the current IPD setting of the electronic device 101, no change to the current IPD setting of the electronic device 101 may be needed.

One or more stored IPD values 640 and the current (possibly updated) IPD setting of the electronic device 101 are provided to a mapping generation operation 642. The current IPD setting of the electronic device 101 may be the new setting identified by the IPD measurement and device adjustment operation 612 or the previous (unchanged) IPD setting. The mapping generation operation 642 generally operates to generate or otherwise obtain one or more mappings used to perform passthrough transformations or other modifications to the image frames captured using the one or more see-through cameras 542 or other imaging sensors 180 of the electronic device 101 and obtained by the scene image frame capture function 604. The mapping generation operation 642 includes a stored IPD retrieval function 644, which can obtain one or more stored IPD values 640 from the database 408. Each stored IPD value 640 may be associated with one or more mappings that were previously generated for that stored IPD value 640.

A mapping creation function 646 generally operates to identify mappings (such as mathematical transformations) between the position(s) of the see-through camera(s) 542 or other imaging sensor(s) 180 of the electronic device 101 and the positions of the user's eyes 206. As noted above, in some embodiments, this can involve the identification of translations and/or rotations needed to adjust image frames captured at the position(s) of the see-through camera(s) 542 or other imaging sensor(s) 180 in order to make it appear as if the image frames were captured at the positions of the user's eyes 206. Among other things, these mappings can be used to support viewpoint matching and parallax correction.

In some cases, the mappings identified by the mapping creation function 646 may be new mappings, such as one or more mappings generated in response to the current IPD setting of the electronic device 101 not matching any stored IPD values 640. In other cases, the mappings identified by the mapping creation function 646 may be prior mappings, such as one or more mappings previously generated and stored in the database 408 in association with a specified one of the stored IPD values 640. In the former case, the mapping creation function 646 may store the new mapping(s) in the database 408 in association with the new IPD setting of the electronic device 101. In the latter case, the mapping creation function 646 may retrieve the prior mapping(s) from the database 408.

The one or more mappings identified by the mapping generation operation 642 can be provided to a passthrough transformation operation 648, which generally operates to apply the mapping(s) to the image frames captured by the one or more see-through cameras 542 or other imaging sensors 180 of the electronic device 101. The resulting transformed image frames are provided to a frame rendering operation 650, which generally operates to render the transformed image frames and initiate display of the resulting rendered images. The operations 648 and 650 may be the same as or similar to the passthrough transformation operation 414 and frame rendering operation 416, respectively.

Although FIG. 6 illustrates one example of an architecture 600 supporting automated interpupillary distance estimation and device adjustment for XR or other applications, various changes may be made to FIG. 6. For example, various components, operations, or functions in FIG. 6 may be combined, further subdivided, replicated, omitted, or rearranged and additional components, operations, or functions may be added according to particular needs.

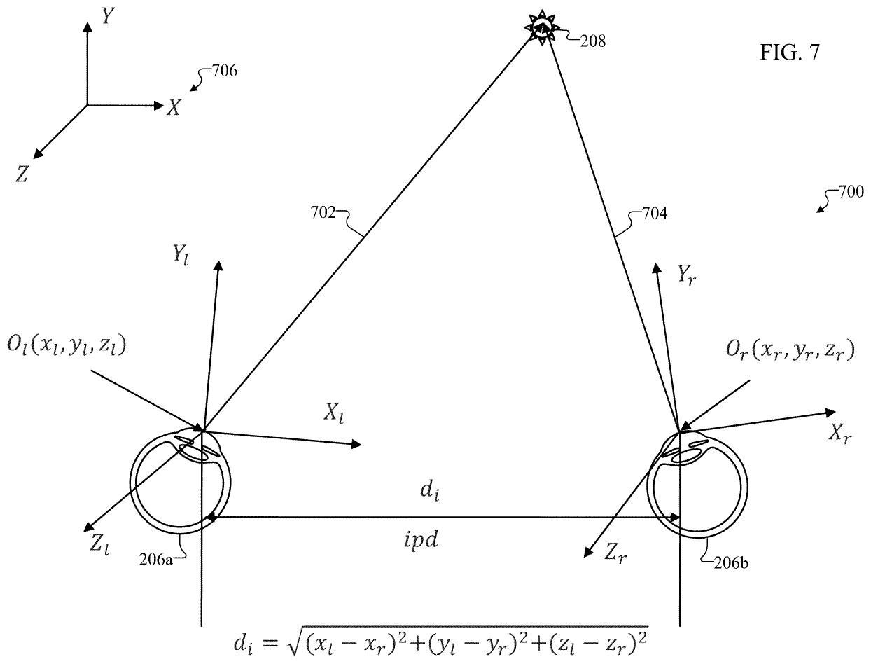

FIG. 7 illustrates an example technique 700 for interpupillary distance estimation based on eye focal point tracking in accordance with this disclosure. For ease of explanation, the technique 700 shown in FIG. 7 is described as being performed using the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the technique 700 may be performed using any other suitable device(s) and in any other suitable system(s), and the technique 700 may be used to implement any other suitable process(es) and architecture(s) designed in accordance with this disclosure.

As shown in FIG. 7, the user's left eye 206a and the user's right eye 206b are focused inward towards a target point 208. The target point 208 may represent a point on which the user 202 is focused, such as a point in an artificial pattern or a point of an object within the scene being viewed by the user 202. While the user 202 is focusing on the target point 208, the eye-tracking imaging sensors 304 can capture image frames of the user's left and right eyes 206a-206b. Through suitable image processing (such as by the eye gaze determination function 624), a left gaze vector 702 and a right gaze vector 704 can be identified. The gaze vectors 702, 704 identify the gaze directions for the user's eyes 206a-206b when focused on the target point 208.

Based on the image frames capturing the user's eyes 206a-206b, an origin of the user's left eye 206a can be determined, such as by identifying the center of the user's left pupil. The position of the origin of the user's left eye 206a can be expressed as Oₗ(xₗ, yₗ, zₗ). Similarly, an origin of the user's right eye 206b can be determined, such as by identifying the center of the user's right pupil. The position of the origin of the user's right eye 206b can be expressed as Oᵣ(xᵣ, yᵣ, zᵣ). From this, it is possible (such as by using the user IPD identification function 628) to estimate the user's interpupillary distance 212 (denoted dᵢ here). In some cases, the user's interpupillary distance 212 can be calculated in the following manner.

$${d}_{i} = \sqrt{{( {x}_{l} - {x}_{r} )}^{2} + {( {y}_{l} - {y}_{r} )}^{2} + {( {z}_{l} - {z}_{r} )}^{2}}$$

Here, the coordinates of the two origins (the centers of the user's pupils) can be defined within a global coordinate system 706, and the user's interpupillary distance 212 can be determined based on the identified positions of the centers of the user's pupils.

Note that estimates of the user's interpupillary distance 212 might undergo small changes when the user's focal distance 210 changes, which can be due to slight movements of the user's eyes 206a-206b. This can be handled in various ways. For example, in some cases, the user 202 may be asked to focus on different target points 208 at different depths, and multiple interpupillary distance estimates can be identified and averaged in order to estimate an average interpupillary distance 212 for the user 202. Thus, for instance, a checkerboard pattern or other pattern may be displayed to the user 202 at different depths within a scene, the user 202 may be asked to focus on a center or other portion of the pattern at each depth within the scene, and the resulting interpupillary distance estimates can be identified and averaged.

Although FIG. 7 illustrates one example of a technique 700 for interpupillary distance estimation based on eye focal point tracking, various changes may be made to FIG. 7. For example, the locations of the user's pupils may be expressed in any other suitable manner, such as when one pupil center is treated as the origin of a coordinate system and the other pupil center is treated as being offset from that origin.

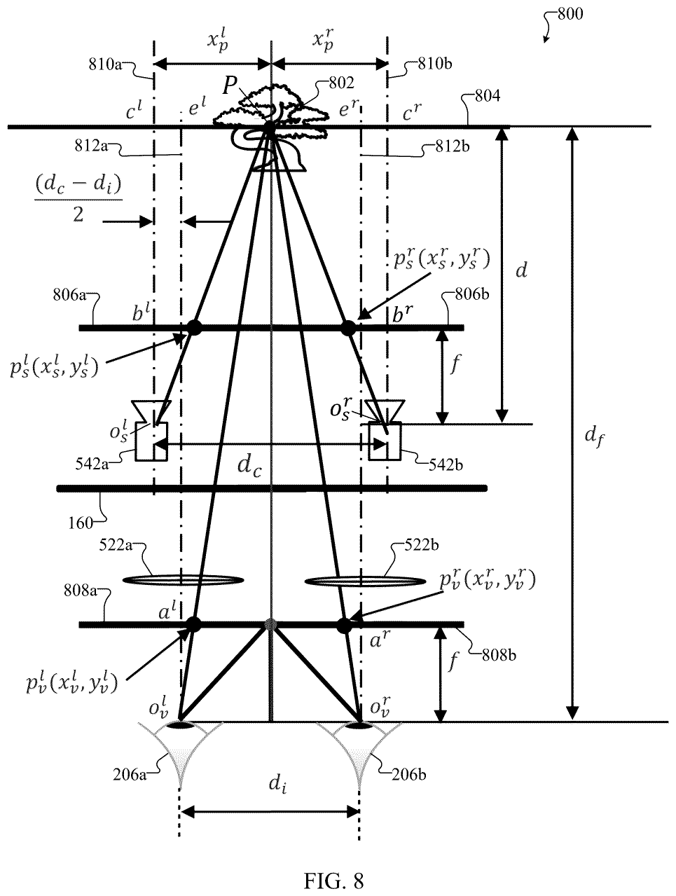

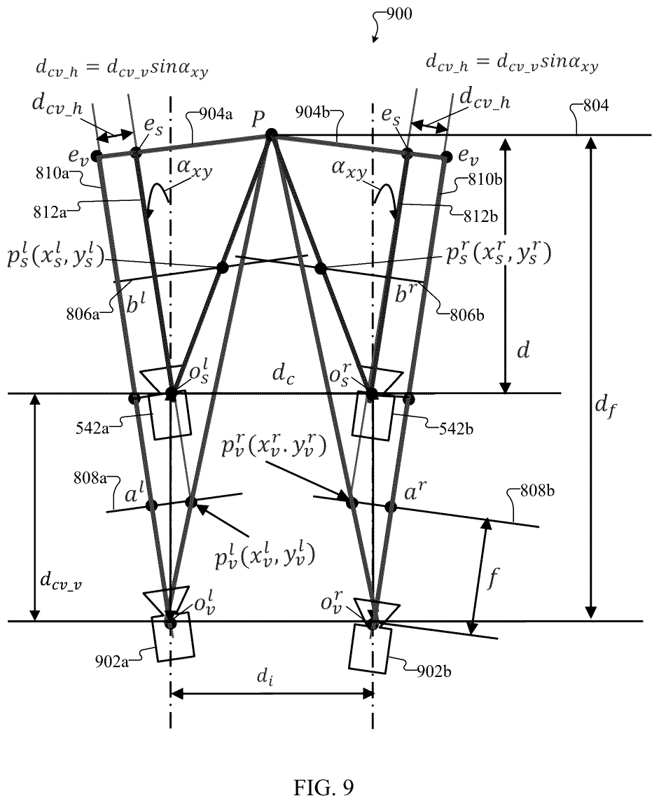

FIGS. 8 and 9 illustrate example relationships 800 and 900 associated with interpupillary distance estimation based on eye focal point tracking in accordance with this disclosure. For case of explanation, the relationships 800 and 900 shown in FIGS. 8 and 9 are described as being used by the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the relationships 800 and 900 may be used by any other suitable device(s) and in any other suitable system(s), and the relationships 800 and 900 may be used in any other suitable process(es) and architecture(s) designed in accordance with this disclosure.

As shown in FIG. 8, the user's eyes 206a-206b are viewing a scene that includes a target point P associated with an object 802 (which in this example represents a tree). The target point P is located on an image plane 804. Two see-through cameras 542a-542b are used to capture image frames of the scene, and the see-through cameras 542a-542b can capture the image frames at image planes 806a-806b associated with the see-through cameras 542a-542b. One or more displays 160 present rendered images to the user, and the one or more displays 160 are viewed by the user through two display lenses 522a-522b. The display lenses 522a-522b focus the rendered images onto image planes 808a-808b that are viewed by the user's eyes 206a-206b.

In the example shown in FIG. 8, the notation d represents the depth of the target point P of the object 802 from the see-through cameras 542a-542b, and the notation d_{f} represents the focal distance 210 of the user's eyes 206a-206b to the target point P of the object 802. Also, the notation dᵢ represents the user's interpupillary distance, and the notation d_{c} represents the distance between the see-through cameras 542a-542b. Further, the notation

$${p}_{s}^{l} ( {x}_{s}^{l} , {y}_{s}^{l} )$$

represents the location of the target point P in a left see-through image frame captured at the image plane 806a, and the notation

$${p}_{s}^{r} ( {x}_{s}^{r} , {y}_{s}^{r} )$$

represents the location of the target point P in a right see-through image frame captured at the image plane 806b. In addition, the notation

$${p}_{v}^{l} ( {x}_{v}^{l} , {y}_{v}^{l} )$$

represents the location of the target point P in a left virtual image generated at the image plane 808a, and the notation

$${p}_{v}^{r} ( {x}_{v}^{r} , {y}_{v}^{r} )$$

represents the location of the target point P in a right virtual image generated at the image plane 808b.

With knowledge of the focal point (the target point P) and the focal distance d_{f} (which can be determined using eye tracking), the user's interpupillary distance 212 may be estimated as follows. Based on

$$Δ {o}_{s}^{l} P {c}^{l} and Δ {o}_{s}^{l} {p}_{s}^{l} {b}^{l} ,$$

the following relationship can be defined.

$$\frac{{x}_{p}^{l}}{{x}_{s}^{l}} = \frac{d}{f}$$

Also, based on

$$Δ {o}_{v}^{l} P {e}^{l} and Δ {o}_{v}^{l} {p}_{v}^{l} {a}^{l} ,$$

the following relationship can be defined.

$$\frac{{x}_{p}^{l} - \frac{{d}_{c} - {d}_{i}}{2}}{{x}_{v}^{l}} = \frac{{d}_{f}}{f}$$

From these two relationships, the following expression can be obtained to determine the user's interpupillary distance dᵢ.

$${d}_{i} = {d}_{c} - \frac{2}{f} ( {dx}_{s}^{l} - {d}_{f} {x}_{v}^{l} )$$

In FIG. 8, the see-through cameras 542a-542b are assumed to point straight ahead as shown by their optical axes 810a-810b. The see-through cameras 542a-542b are also assumed to be off-axis relative to the user's eyes 206a-206b, which can be seen by the separation of the optical axes 810a-810b of the see-through cameras 542a-542b from optical axes 812a-812b of the user's eyes 206a-206b. In the example of FIG. 8, the notations a^{l} and e^{l} represent locations where the optical axis 812a intersects the image planes 808a and 804, respectively, and the notations b^{l} and c^{l} represent the locations where the optical axis 810a intersects the image planes 806a and 804, respectively. Similarly, the notations a^{r} and e^{r} represent locations where the optical axis 812b intersects the image planes 808b and 804, respectively, and the notations b^{r} and c^{r} represent the locations where the optical axis 810b intersects the image planes 806b and 804, respectively.

The notation f represents focal length between the user's eyes 206a-206b and the image planes 808a-808b. The notations

$${x}_{p}^{l} and {x}_{p}^{r}$$

represent distances between the optical axes 810a-810b and the target point P. The notations

$${o}_{s}^{l} and {o}_{s}^{r}$$

represent the origins of the see-through cameras 542a-542b, and the notations oᵥ^{l} and oᵥ^{r} represent the origins of the user's eyes 206a-206b. Based on this, the distance between the optical axes 810a and 812a can be expressed as (d_{c}−dᵢ)/2, and the distance between optical axes 810b and 812b can also be expressed as (d_{c}−dᵢ)/2.

Note that the see-through cameras 542a-542b need not point straight ahead and/or need not be off-axis relative to the user's eyes 206a-206b. For example, FIG. 9 illustrates an example where the see-through cameras 524a-524b are aligned with virtual cameras 902a-902b (which represent the user's eyes 206a-206b in this example). Moreover, each see-through camera 542a-542b is angled outward at a specified angle α_{xy}, and each virtual camera 902a-902b is angled outward at the same specified angle α_{xy}. Because of this rotation, the see-through cameras 542a-542b can capture image frames along image planes 904a-904b, which are angled relative to the image plane 804. Note that the display lenses 522a-522b are omitted here for clarity but can be included.

The notation eᵥ denotes points on the image planes 904a-904b that intersect the optical axes 810a-810b, and the notation eₛ denotes points on the image planes 904a-904b that intersect the optical axes 812a-812b. The notation d_{cv_h} represents a distance between one of the optical axes 810a-810b and an associated one of the optical axes 812a-812b. The notation d_{cv_v} represents a distance between a see-through camera 524a or 524b and a corresponding one of the virtual cameras 902a or 902b. In this example, it can be seen that d_{cv_h}=d_{cr_v} sin α_{xy}. It is possible to derive a similar mathematical model as was done with respect to FIG. 8 in order to estimate the user's interpupillary distance dᵢ based on knowledge of the user's focus on the target point P.

Note that it is assumed in FIGS. 8 and 9 that the depth d between each sec-through camera 524a-524b and the target point P is available, such as from a depth sensor or measured or derived in any other suitable manner. However, use of the depth d is not necessarily required. For instance, it may be possible to derive the depth d from the focal depth d_{f} and one or more known parameters of the electronic device 101. As a particular example, the distance between the center of each user's eye 206a or 206b and the lens center of the corresponding sec-through camera 524a or 524b (which may include eye relief, meaning an eye center to a display lens center), the distance between a display lens center and a display panel center (assuming each eye 206a-206b views its own display panel), and the distance between the display panel and the lens center of the corresponding see-through camera 524a or 524b may be used. In this way, the only depth that may need to be measured or derived could be the focal depth d_{f} of the target point P in order to compute the user's interpupillary distance.

Although FIGS. 8 and 9 illustrate examples of relationships 800, 900 associated with interpupillary distance estimation based on eye focal point tracking, various changes may be made to FIGS. 8 and 9. For example, the specific positions of the see-through cameras 524a-524b relative to the user's eyes 206a-206b or virtual cameras 902a-902b shown here are for illustration and explanation only and can vary as needed or desired.

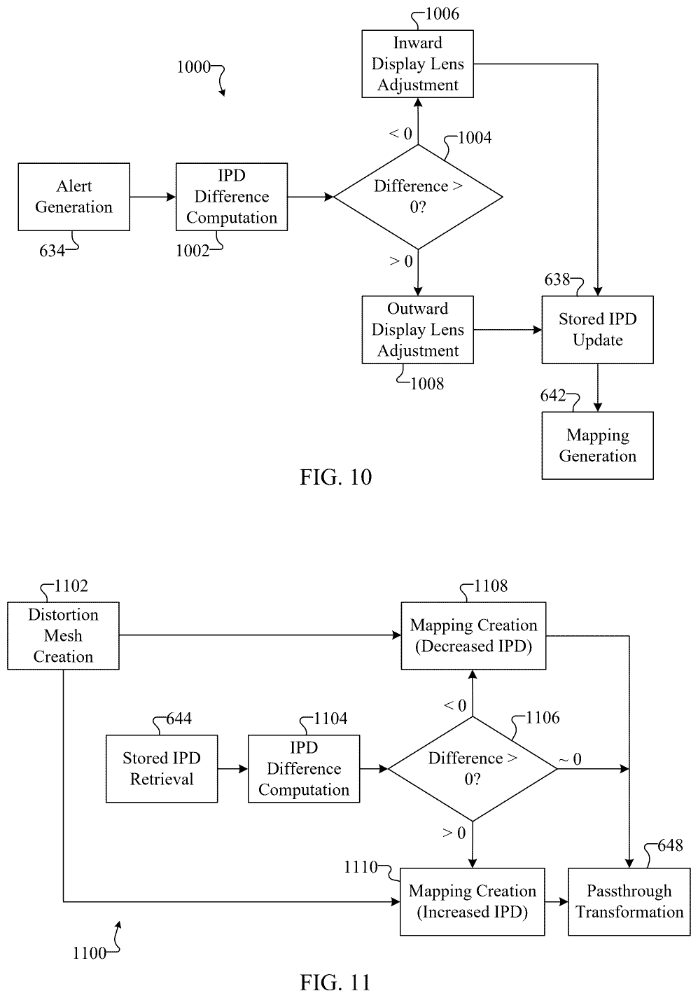

FIG. 10 illustrates an example process 1000 for device adjustment based on automated interpupillary distance estimation in accordance with this disclosure. For case of explanation, the process 1000 shown in FIG. 10 is described as being performed using or as involving the use of the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. For example, the process 1000 may be used as at least part of the motor-driven IPD adjustment function 636 described above. However, the process 1000 may be performed using any other suitable device(s) and in any other suitable system(s).

As shown in FIG. 10, the alert generation function 634 can be used to present an alert to the user 202 indicating that the current IPD setting of the electronic device 101 is being changed. An IPD difference computation function 1002 can determine a difference between the current IPD setting of the electronic device 101 and the desired IPD setting of the electronic device 101. The desired IPD setting of the electronic device 101 can represent the interpupillary distance of the user 202 as determined using the techniques described above. In some cases, this difference can be expressed as follows.

$${δ}_{ipd} = {d}_{i u} - {d}_{i d}$$

Here, the notation δ_{ipd} represents the difference, the notation dᵢᵤ represents the estimated interpupillary distance of the user 202, and the notation d_{id} represents the current IPD setting of the electronic device 101.

A comparison function 1004 determines if the difference is above or below zero. A difference less than zero indicates that the estimated interpupillary distance of the user 202 is smaller than the current IPD setting of the electronic device 101. In that case, an inward display lens adjustment function 1006 can be used to cause the display lenses 522a-522b of the electronic device 101 to move inward. For example, the inward display lens adjustment function 1006 can control the one or more actuators 524 in order to cause the display lenses 522a-522b of the electronic device 101 to move inward. As a particular example, each of the display lenses 522a-522b may be moved inward by a distance of δ_{ipd}/2. In some embodiments, each display lens 522a-522b can have its own digital motor or other actuator 524 that can be controlled to provide the desired adjustment to the position of the display lens 522a-522b.

A difference greater than zero indicates that the estimated interpupillary distance of the user 202 is larger than the current IPD setting of the electronic device 101. In that case, an outward display lens adjustment function 1008 can be used to cause the display lenses 522a-522b of the electronic device 101 to move outward. For example, the outward display lens adjustment function 1008 can control the one or more actuators 524 in order to cause the display lenses 522a-522b of the electronic device 101 to move outward. As a particular example, each of the display lenses 522a-522b may be moved outward by a distance of δ_{ipd}/2. Again, in some embodiments, each display lens 522a-522b can have its own digital motor or other actuator 524 that can be controlled to provide the desired adjustment to the position of the display lens 522a-522b.

Although FIG. 10 illustrates one example of a process 1000 for device adjustment based on automated interpupillary distance estimation, various changes may be made to FIG. 10. For example, while FIG. 10 illustrates the process 1000 as forming part of the architecture 600 shown in FIG. 6, the process 1000 may be used in conjunction with any other suitable architecture.

FIG. 11 illustrates an example process 1100 for passthrough transformation mapping based on automated interpupillary distance estimation in accordance with this disclosure. For case of explanation, the process 1100 shown in FIG. 11 is described as being performed using or as involving the use of the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. For example, the process 1100 may be used as at least part of the stored IPD retrieval function 644 and the mapping creation function 646 described above. However, the process 1100 may be performed using any other suitable device(s) and in any other suitable system(s).

As shown in FIG. 11, the process 1100 includes a distortion mesh creation function 1102, which generally operates to create a distortion mesh for each image frame captured by a see-through camera 524a-524b. Depending on the circumstances, each image frame may have its own distortion mesh, or a distortion mesh may be shared across multiple image frames (such as image frames captured using little or no user head motion). Each distortion mesh represents a mesh of points that defines how at least one image frame can be transformed or distorted to correct for various issues.

In some cases, each distortion mesh may represent a predefined mesh, such as a rectilinear or other regular mesh of points. In other cases, each distortion mesh may be based on one or more characteristics of the at least one see-through camera 524a-524b that is used to capture image frames to be processed. For instance, the distortion mesh creation function 1102 may include or have access to camera and display panel configuration parameters, which can define parameters of one or more imaging sensors 180 (such as one or more see-through cameras 524a-524b) used to capture image frames and one or more displays 160 (such as one or more display panels) used to present rendered images. The configuration parameters may identify any suitable characteristics of the imaging sensor(s) 180 and display(s) 160, such as sizes/resolutions and locations of the imaging sensor(s) 180 and display(s) 160. Each distortion mesh can identify how an image frame captured using an imaging sensor 180 might need to be distorted for proper presentation on an associated display 160.

The stored IPD retrieval function 644 can be used to obtain a stored IPD setting of the electronic device 101 and associated mapping(s), such as by retrieving a stored IPD value 640 from the database 408 and any previously-calculated mapping(s) associated with that stored IPD value 640. An IPD difference computation function 1104 can determine a difference between the current IPD setting of the electronic device 101 and the stored IPD value 640 (which can represent a prior IPD setting of the electronic device 101). In some cases, the difference can be expressed as follows.

$${δ}_{ipd} = {d}_{i d} - {d}_{i c}$$

Here, the notation d_{id} represents the current IPD setting of the electronic device 101, and the notation d_{ic} represents the stored IPD setting.

A comparison function 1106 determines if the difference is above or below zero. A difference less than zero indicates that the current IPD setting of the electronic device 101 is smaller than the stored IPD setting. In that case, a mapping creation function 1108 with decreased IPD may be used to generate one or more mappings associated with a smaller IPD setting of the electronic device 101. For example, the mapping creation function 1108 may create one or more new mappings with a decreased IPD value based on 2δ=δ_{ipd}, where δ represents the value of IPD change relative to each of the user's left and right eyes 206a-206b. As a particular example, the mapping creation function 1108 can modify the distortion mesh from the distortion mesh creation function 1102 in order to account for the smaller IPD setting of the electronic device 101.

A difference greater than zero indicates that the current IPD setting of the electronic device 101 is larger than the stored IPD setting. In that case, a mapping creation function 1110 with increased IPD may be used to generate one or more mappings associated with a larger IPD setting of the electronic device 101. For example, the mapping creation function 1110 may create one or more new mappings with an increased IPD value based on 2δ=δ_{ipd}. As a particular example, the mapping creation function 1110 can modify the distortion mesh from the distortion mesh creation function 1102 in order to account for the larger IPD setting of the electronic device 101. A difference of zero or approximately zero (such as within a threshold amount of zero) may not involve any new mapping(s), and one or more mappings associated with the stored IPD setting of the electronic device 101 may be obtained and used, such as when the mapping(s) retrieved from the database 408 can be used.

In some embodiments, the mappings that are used here may be defined as follows. Assume that a mapping between a see-through camera image frame (captured at the viewpoint of a see-through camera 524a or 524b) is being mapped to a virtual camera image frame (associated with the viewpoint of a user's eye 206a or 206b) after an IPD change. Here, a mapping to transform points

$${p}_{s}^{l} ( {x}_{s}^{l} , {y}_{s}^{l} )$$

into points

$${p}_{v}^{l} ( {x}_{v}^{l} , {y}_{v}^{l} )$$

for the user's left eye 200a may be defined as follows.

$$\{ \begin{matrix}\frac{{x}_{p}^{l}}{{x}_{s}^{l}} = \frac{d}{f} \\ \frac{{x}_{p}^{l} - \frac{{d}_{c} - {d}_{i}}{2}}{{x}_{v}^{l}} = \frac{{d}_{f}}{f}\end{matrix}$$

$${x}_{v}^{l} = \frac{f}{{d}_{f}} ( \frac{d}{f} {x}_{s}^{l} - \frac{{d}_{c} - {d}_{i}}{2} )$$

Similarly, the following can be obtained.

$${y}_{v}^{l} = \frac{f}{{d}_{f}} ( \frac{d}{f} {y}_{s}^{l} - \frac{{d}_{c} - {d}_{i}}{2} )$$

A similar approach can be used to define the mapping associated with the user's right eye 206b. Thus, it is possible to create mappings for left and right image frames that are defined as follows.

$$\{ \begin{matrix}{x}_{v}^{l} = \frac{f}{{d}_{f}} ( \frac{d}{f} {x}_{s}^{l} - \frac{{d}_{c} - {d}_{i}}{2} ) \\ {y}_{v}^{l} = \frac{f}{{d}_{f}} ( \frac{d}{f} {y}_{s}^{l} - \frac{{d}_{c} - {d}_{i}}{2} )\end{matrix}$$

$$\{ \begin{matrix}{x}_{v}^{r} = \frac{f}{{d}_{f}} ( \frac{d}{f} {x}_{s}^{r} - \frac{{d}_{c} - {d}_{i}}{2} ) \\ {y}_{v}^{r} = \frac{f}{{d}_{f}} ( \frac{d}{f} {y}_{s}^{r} - \frac{{d}_{c} - {d}_{i}}{2} )\end{matrix}$$

Note that this assumes the arrangement shown in FIG. 8 is being used. Other mappings can be derived mathematically for other arrangements, such as the arrangement shown in FIG. 9.

Although FIG. 11 illustrates one example of a process 1100 for passthrough transformation mapping based on automated interpupillary distance estimation, various changes may be made to FIG. 11. For example, while FIG. 11 illustrates the process 1100 as forming part of the architecture 600 shown in FIG. 6, the process 1100 may be used in conjunction with any other suitable architecture.

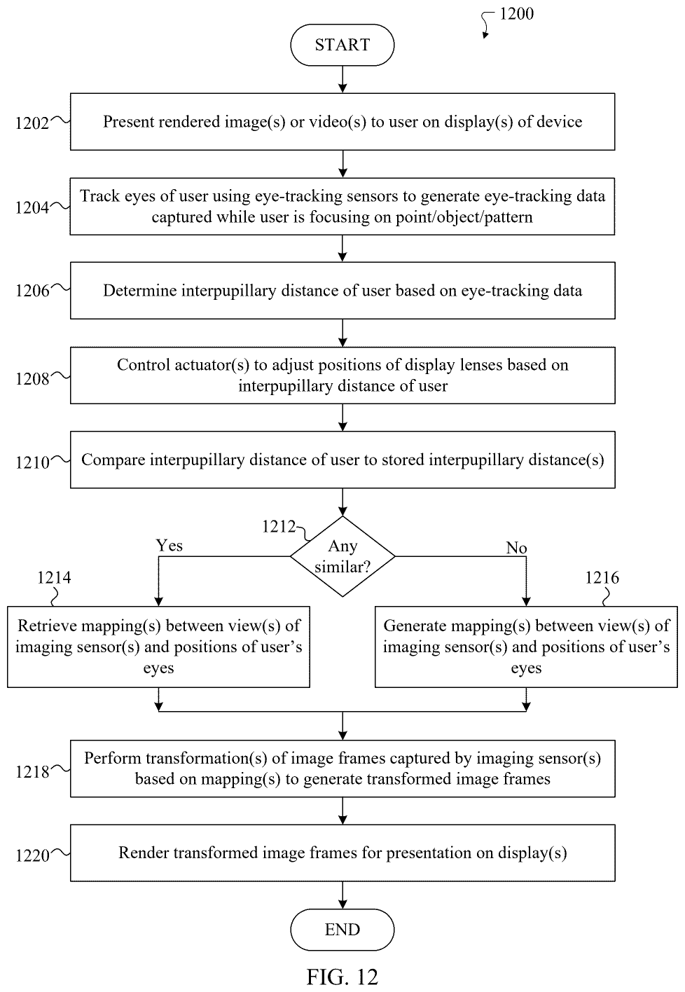

FIG. 12 illustrates an example method 1200 for automated interpupillary distance estimation and device adjustment for XR or other applications in accordance with this disclosure. For ease of explanation, the method 1200 shown in FIG. 12 is described as being performed using or as involving the use of the electronic device 101 in the network configuration 100 shown in FIG. 1, where the electronic device 101 may have the form shown in FIGS. 2 and 3 and may implement the process 400 shown in FIG. 4 and the architecture 600 of FIG. 6. However, the method 1200 may be performed using any other suitable device(s) and in any other suitable system(s), and the method 1200 may be implemented using any other suitable process(es) and architecture(s) designed in accordance with this disclosure.

As shown in FIG. 12, one or more rendered images or videos are presented to a user on one or more displays of an XR headset or other device at step 1202. This may include, for example, the processor 120 of the electronic device 101 presenting one or more rendered images or videos to a user 202 on at least one display 160 of the electronic device 101. The one or more rendered images or videos can include at least one object, point, or pattern on which the user 202 focuses his or her eyes 206a-206b. The eyes of the user are tracked using eye-tracking sensors to generate eye-tracking data at step 1204. This may include, for example, the processor 120 of the electronic device 101 obtaining image frames of the user's eyes 206a-206b from the eye-tracking imaging sensors 304 while the user 202 is focusing his or her eyes 206a-206b on the displayed object, point, or pattern.

An interpupillary distance of the user is determined based on the eye-tracking data at step 1206. This may include, for example, the processor 120 of the electronic device 101 using the image frames capturing the user's eyes 206a-206b and pupil and corneal reflections 306, 308 to measure the gaze directions, focal point, and/or focal distance of the user's eyes 206a-206b. As particular examples, the processor 120 of the electronic device 101 may use the relationships 800 of FIG. 8 or the relationships 900 of FIG. 900 to estimate the user's interpupillary distance di. In some cases, the processor 120 of the electronic device 101 may identify multiple estimates of the user's interpupillary distance (such as when the user 202 focuses at different locations or different depths) and average the multiple estimates. One or more actuators are controlled to adjust positions of display lenses based on the user's estimated interpupillary distance at step 1208. This may include, for example, the processor 120 of the electronic device 101 controlling the one or more actuators 524 in order to move the display lenses 522a-522b inward or outward.

In some cases, additional operations may occur based on or using the user's estimated interpupillary distance. For example, the user's estimated interpupillary distance can be compared to one or more stored interpupillary distances previously identified by the electronic device at step 1210, and a determination can be made whether the user's estimated interpupillary distance is adequately similar (such as to within a threshold amount or percentage) to any of the stored interpupillary distances at step 1212. This may include, for example, the processor 120 of the electronic device 101 comparing the user's estimated interpupillary distance to one or more stored interpupillary distances in the database 408. If there is a similar stored interpupillary distance, one or more mappings associated with the stored interpupillary distance can be retrieved at step 1214. This may include, for example, the processor 120 of the electronic device 101 retrieving one or more previously-generated mappings associated with the similar stored interpupillary distance from the database 408. If there is not a similar stored interpupillary distance, one or more mappings associated with the user's estimated interpupillary distance can be generated at step 1216. This may include, for example, the processor 120 of the electronic device 101 generating one or more new mappings associated with the user's estimated interpupillary distance. In either case, one or more transformations based on the retrieved or generated mapping(s) can be applied to image frames captured using one or more imaging sensors of the device at step 1218, and the resulting transformed image frames can be rendered for presentation at step 1220. This may include, for example, the processor 120 of the electronic device 101 applying translations, rotations, or other transformations based on the retrieved or generated mapping(s) and rendering the resulting transformed image frames.

Although FIG. 12 illustrates one example of a method 1200 for automated interpupillary distance estimation and device adjustment for XR or other applications, various changes may be made to FIG. 12. For example, while shown as a series of steps, various steps in FIG. 12 may overlap, occur in parallel, occur in a different order, or occur any number of times (including zero times).

It should be noted that the functions shown in or described with respect to FIGS. 2 through 12 can be implemented in an electronic device 101, 102, 104, server 106, or other device(s) in any suitable manner. For example, in some embodiments, at least some of the functions shown in or described with respect to FIGS. 2 through 12 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 12 can be implemented or supported using dedicated hardware components. In general, the functions shown in or described with respect to FIGS. 2 through 12 can be performed using any suitable hardware or any suitable combination of hardware and software/firmware instructions. Also, the functions shown in or described with respect to FIGS. 2 through 12 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus configured to be worn on a head of a user, the apparatus comprising:
at least one display configured to present one or more rendered images or videos to the user;
at least one eye-tracking sensor configured to track eyes of the user; and
at least one processing device configured to:
obtain eye-tracking data captured using the at least one eye-tracking sensor while the user is focusing on a point, object, or pattern within at least one rendered image or video presented on the at least one display; and
determine an interpupillary distance of the user based on the eye-tracking data.

2. The apparatus of claim 1, further comprising:
display lenses configured to be positioned between the at least one display and the user's eyes; and
one or more actuators configured to adjust positions of the display lenses;
wherein the at least one processing device is further configured to control the one or more actuators to adjust the positions of the display lenses based on the determined interpupillary distance of the user.

3. The apparatus of claim 2, wherein the at least one processing device is further configured to:
obtain one or more mappings between one or more views of at least one imaging sensor and positions of the user's eyes, the one or more mappings based on the determined interpupillary distance of the user;
perform one or more transformations of image frames captured by the at least one imaging sensor based on the one or more mappings after adjustment of the positions of the display lenses to generate transformed image frames; and
render the transformed image frames for presentation on the at least one display.

4. The apparatus of claim 3, wherein the at least one processing device is further configured to:
compare (i) the determined interpupillary distance of the user and (ii) one or more stored interpupillary distances;
in response to the determined interpupillary distance of the user differing from the one or more stored interpupillary distances by at least a threshold, create the one or more mappings and store the determined interpupillary distance and the one or more mappings in at least one memory; and
in response to the determined interpupillary distance of the user not differing from a specified one of the one or more stored interpupillary distances by at least the threshold, retrieve the one or more mappings associated with the specified stored interpupillary distance from the at least one memory.

5. The apparatus of claim 1, wherein the eye-tracking data comprises at least one of: a focal point for at least one of the user's eyes, a focal distance for at least one of the user's eyes, or an eye gaze direction for at least one of the user's eyes.

6. The apparatus of claim 1, further comprising:
at least one imaging sensor configured to capture image frames of a scene; and
at least one depth sensor configured to identify depth data associated with the scene;
wherein the at least one processing device is configured to determine the interpupillary distance of the user based on the depth data.

7. The apparatus of claim 1, wherein:
the at least one processing device is further configured to identify positions of pupils of the user's eyes in a global coordinate system; and
the at least one processing device is configured to determine the interpupillary distance of the user based on the identified positions of the pupils.

8. A method comprising:
presenting one or more rendered images or videos to a user on at least one display of a device configured to be worn on a head of the user;
tracking eyes of the user using at least one eye-tracking sensor to generate eye-tracking data captured while the user is focusing on a point, object, or pattern within at least one rendered image or video presented on the at least one display; and
determining an interpupillary distance of the user based on the eye-tracking data.

9. The method of claim 8, wherein:
display lenses are configured to be positioned between the at least one display and the user's eyes; and
the method further comprises controlling one or more actuators configured to adjust positions of the display lenses based on the determined interpupillary distance of the user.

10. The method of claim 9, further comprising:
obtaining one or more mappings between one or more views of at least one imaging sensor and positions of the user's eyes, the one or more mappings based on the determined interpupillary distance of the user;
performing one or more transformations of image frames captured by the at least one imaging sensor based on the one or more mappings after adjustment of the positions of the display lenses to generate transformed image frames; and
rendering the transformed image frames for presentation on the at least one display.

11. The method of claim 10, further comprising:
comparing (i) the determined interpupillary distance of the user and (ii) one or more stored interpupillary distances; and
one of:
in response to the determined interpupillary distance of the user differing from the one or more stored interpupillary distances by at least a threshold, creating the one or more mappings and storing the determined interpupillary distance and the one or more mappings in at least one memory; and
in response to the determined interpupillary distance of the user not differing from a specified one of the one or more stored interpupillary distances by at least the threshold, retrieving the one or more mappings associated with the specified stored interpupillary distance from the at least one memory.

12. The method of claim 8, wherein the eye-tracking data comprises at least one of: a focal point for at least one of the user's eyes, a focal distance for at least one of the user's eyes, or an eye gaze direction for at least one of the user's eyes.

13. The method of claim 8, further comprising:
capturing image frames of a scene using at least one imaging sensor; and
identifying depth data associated with the scene using at least one depth sensor;
wherein the interpupillary distance of the user is based on the depth data.

14. The method of claim 8, further comprising:
identifying positions of pupils of the user's eyes in a global coordinate system; and
wherein the interpupillary distance of the user is based on the identified positions of the pupils.

15. A non-transitory machine readable medium containing instructions that when executed cause at least one processor of an electronic device configured to be worn on a head of a user to:
initiate presentation of one or more rendered images or videos to the user on at least one display of the electronic device;
obtain eye-tracking data associated with eyes of the user from at least one eye-tracking sensor while the user is focusing on a point, object, or pattern within at least one rendered image or video presented on the at least one display; and
determine an interpupillary distance of the user based on the eye-tracking data.

16. The non-transitory machine readable medium of claim 15, further containing instructions that when executed cause the at least one processor to control one or more actuators configured to adjust positions of display lenses positioned between the at least one display and the user's eyes based on the determined interpupillary distance of the user.

17. The non-transitory machine readable medium of claim 16, further containing instructions that when executed cause the at least one processor to:
obtain one or more mappings between one or more views of at least one imaging sensor and positions of the user's eyes, the one or more mappings based on the determined interpupillary distance of the user;
perform one or more transformations of image frames captured by the at least one imaging sensor based on the one or more mappings after adjustment of the positions of the display lenses to generate transformed image frames; and
render the transformed image frames for presentation on the at least one display.

18. The non-transitory machine readable medium of claim 17, further containing instructions that when executed cause the at least one processor to
compare (i) the determined interpupillary distance of the user and (ii) one or more stored interpupillary distances;
in response to the determined interpupillary distance of the user differing from the one or more stored interpupillary distances by at least a threshold, create the one or more mappings and store the determined interpupillary distance and the one or more mappings in at least one memory; and
in response to the determined interpupillary distance of the user not differing from a specified one of the one or more stored interpupillary distances by at least the threshold, retrieve the one or more mappings associated with the specified stored interpupillary distance from the at least one memory.

19. The non-transitory machine readable medium of claim 15, further containing instructions that when executed cause the at least one processor to:
capture image frames of a scene using at least one imaging sensor; and
identify depth data associated with the scene using at least one depth sensor;
wherein the interpupillary distance of the user is based on the depth data.

20. The non-transitory machine readable medium of claim 15, further containing instructions that when executed cause the at least one processor to identify positions of pupils of the user's eyes in a global coordinate system;
wherein the interpupillary distance of the user is based on the identified positions of the pupils.
